(19) United States
(12) Patent Application Publication
(10) Pub. No.: US 2022/0363844 A1
(43) Pub. Date: Nov. 17, 2022

(54) IMPROVED THERMOPLASTIC POLYURETHANE

(71) Applicant: DUPONT POLYMERS, INC., Wilmington, DE (US)

(72) Inventors: Pijush K. Dewanjee, Carlsbad, CA (US); John Gilbert Guard, Oceanside, CA (US)

(21) Appl. No.: 17/754,638

(22) PCT Filed: Oct. 8, 2020
(86) PCT No.: PCT/US2020/054751

§ 371 Date: Apr. 7, 2022

Related U.S. Application Data
(60) Provisional application No. 62/912,728, filed on Oct. 9, 2019.

(51) Int. Cl. C08J 3/24; C08G 18/76; C08G 18/42; C08G 18/38

(52) U.S. Cl. CPC C08J 3/247; C08G 18/7671; C08G 18/4277; C08G 18/3814; C08J 2375/06

(57) ABSTRACT

The invention provides a method for the production of a cross-linked Thermoplastic Polyurethane (TPU) moulded article.

### FIELD OF INVENTION

The present invention relates to the field of thermoplastic polyurethanes.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Thermoplastic polyurethanes (“TPU's”) are a group of block copolymers consisting of alternating sequences of hard and soft segments or domains formed by the reaction of: (1) diisocyanates with short-chain diols (so-called chain extenders) and (2) diisocyanates with long-chain diols. By varying the ratio, structure and/or molecular weight of the reaction compounds, an enormous variety of different TPU's can be produced.

TPU has many applications including automotive instrument panels, caster wheels, power tools, sporting goods, medical devices, drive belts, footwear, inflatable rafts, and a variety of extruded film, sheet and profile applications. TPU is also a popular material found in outer cases of mobile electronic devices, such as mobile phones. It is also used to make keyboard protectors for laptops.

TPU's show excellent elasticity, maintenance of mechanical properties at low temperature and good fatigue performance. However, they typically are adversely affected by organic solvents or by high- and low-pH, water; and they typically show only moderate abrasion resistance, cut resistance, creep under high loads at elevated temperature and poor compression set, compared to traditional thermoset elastomers.

Dewanjee et al., in U.S. Pat. No. 7,417,094, describe a method for forming cross-linked TPU's that address some of these drawbacks. The method involves mixing in the melt a TPU, a 4,4′-diphenylmethane diisocyanate and 4,4′methylene bis-(3-chloro-2,6-diethylaniline). The molten mixture is then injection molded into a mold cavity to form a cross-linked TPU article. The articles are said to have improved abrasion resistance. While the properties of the cross-linked material are excellent, the method suffers the drawback that the manufacturer of the article (i.e. extrusion and injection molders) must store and work with diisocyanate. Extrusion and injection molders are typically not equipped to deal with diisocyanates, which are moisture sensitive and a respiratory hazard.

### SUMMARY OF THE INVENTION

In a first aspect, the invention provides a method for producing a cross-linked TPU article, comprising the steps:
(1) creating a molten blend of at least one TPU, a diisocyanate having a boiling point of greater than 200° C. at 1-10 wt %, an aromatic diamine having a boiling point of greater than 200° C. at 0.5-10 wt %, where the weight percentages are based on the weight of the TPU;
(2) forming the molten blend and allowing it to solidify to a solidified cross-linked TPU;
(3) re-melting the solidified cross-linked TPU; and
(4) forming a cross-linked TPU article.

In a second aspect, the invention provides a cross-linked TPU resulting from the reaction of at least one TPU and a diisocyanate having a boiling point of greater than 200° C. (preferably at 1-10 wt %, based on the weight of the TPU) and an aromatic diamine having a boiling point of greater than 200° C. (preferably at 0.5-10 wt %, based on the weight of the TPU) in extruded form.

In a third aspect, the invention provides a cross-linked TPU resulting from the reaction of at least one TPU and a diisocyanate having a boiling point of greater than 200° C. (preferably at 1-10 wt %, based on the weight of the TPU) and an aromatic diamine having a boiling point of greater than 200° C. (preferably at 0.5-10 wt %, based on the weight of the TPU) in the form of granules or flakes.

### DETAILED DESCRIPTION OF THE INVENTION

Definitions and abbreviations

| | |
|---|---|
| MDI | 4,4′-diphenylmethane diisocyanate |
| MCDEA | 4,4′-Methylenebis(3-Chloro-2,6-Diethylaniline) |
| TPU | thermoplastic polyurethane |
| THF | tetrahydrofuran |

The inventors have surprisingly found that when a TPU is cross-linked with a diisocyanate having a boiling point of greater than 200° C. and an aromatic diamine having a boiling point of greater than 200° C., the material shows the benefits of cross-linking, however, the cross-linking is reversible at melt temperatures, meaning the cross-linked product can be re-melted and further processed like a thermoplastic material. On re-solidification after the re-melt the desired properties of a cross-linked material are restored. This is remarkable and entirely unexpected for a cross-linked material.

Significant property improvements in properties/advantages typically arise from cross-linking (as exemplified by Dewanjee et al., in U.S. Pat. No. 7,417,094). However, typical cross-linked materials suffer the disadvantage that the final article is not recyclable either at end of life or immediately as regrind of scrap.

As mentioned previously, Dewanjee et al. describe a method in which TPU is melt-blended with MDI and MCDEA and directly injection molded. This is called the direct process because the cross-linked article is shaped directly from the melt. Cross-linking occurs as the part is injection molded or extruded. The result is a cross-linked TPU that exhibits the properties of a cross-linked material, such as improved compression set, abrasion resistance, and being insoluble in an organic solvent, such as tetrahydrofuran (THF).

Surprisingly, the inventors have found that it is possible to perform thermoplastic melt processing steps on such cross-linked TPU's. This process, in which the cross-linked material is re-melted and further processed to yield a cross-linked article is called the indirect method. In the context of the present application the expressions “indirect” and “indirect process” and “indirect method” refer to the method of the invention.

It is possible to isolate TPU modified by diisocyanate and diamine in a form that can easily be reprocessed, either by grinding up parts that have been formed by the direct process or by performing the reaction of TPU with diisocyanate and diamine in a traditional melt compounding step and making pellets, e.g. using a twin-screw extrusion process.

Reprocessing the reacted product can be done using traditional melt processing techniques such as re-melting followed by injection molding, extrusion or blow-moulding. The properties of articles made using this indirect process are shown to be essentially indistinguishable from those made from the direct process, thus the cross-linking is reversible.

The reversible nature of the cross-linking means not only that the cross-linked material can be recycled numerous times, but that the TPU can be cross-linked at the manufacturing site and extruded into granules, pellets, flakes or other transportable and storable form, and used by extrusion and injection molders like a thermoplastic material. This has the substantial advantage that the injection molder need not handle or store moisture-sensitive diisocyanate. The handling of moisture-sensitive diisocyanate can be done at a resin manufacturer's facility optimized for handling such materials as opposed to risking exposure of the diisocyanate to moisture during storage or in a molding shop leading to poorly controlled cross-linked product and potential exposure to toxic by-products. Additionally, isocyanates are known to present respiratory hazards when in the form of particulates, vapors or aerosols. Using the method of the invention means that these materials can be handled by the resin manufacturer using appropriate engineering controls (local ventilation, appropriate operator monitoring and protective equipment) as opposed to pushing this responsibility to the downstream processor. Since the diisocyanate and diamine are already present in the granules, pellets or flakes and indeed reacted with the polymer backbone, variability due to moisture exposure is essentially eliminated, and hazards for handlers of the resin are also essentially eliminated.

The method of the invention eliminates the need for part manufacturers to blend powders and pellets and accurately meter them into a molding machine. Problems in accuracy can result in variable and unpredictable properties in the cross-linked article.

The method of the invention means that the initial melt-processing of the TPU with diisocyanate and diamine can occur in equipment optimized for mixing and vacuum stripping reaction byproducts, thereby allowing the part manufacturer to work with the pre-reacted product without the concern of increased porosity which can occur if reaction gases are trapped in an injection mold.

In a second aspect, the invention provides a cross-linked TPU in extruded form, resulting from step (2) or step (4) of the method of the invention. In a preferred embodiment, the extruded form is pellets. Pellets are made by two main methods:

1. The molten polymer mixture is extruded though a die in the form of strands directly underwater and relatively quickly cut by a blade. In this method, the strand is partially deformed depending on its viscosity and the cutting speed. As a result, lens-shaped pellets are formed. These typically have a diameter of from 2-6 mm, preferably 3-4 mm, and a thickness of 1-5 mm, preferably 2-3 mm. In a preferred embodiment, the pellets have a diameter of 3-4 mm and a thickness of 2-3 mm.

2. The polymer mixture is extruded though a die in the form of strands cooled in a water bath such that they are fully solidified before cutting by a pelletizer. The result is short strands. These typically have a diameter of from 2-6 mm, preferably 3-4 mm, and a length of 3-7 mm, preferably 4-5 mm. In a preferred embodiment, the pellets have a diameter of 3-4 mm and a length of 4-5 mm.

In preferred embodiments, the pellets have the following dimensions:

1. A diameter of from 2-6 mm, preferably 3-4 mm, and a thickness of 1-5 mm, preferably 2-3 mm. Particularly preferably, the pellets have a diameter of 3-4 mm and a thickness of 2-3 mm.

2. A diameter of from 2-6 mm, preferably 3-4 mm, and a length of 3-7 mm, preferably 4-5 mm. Particularly preferably, the pellets have a diameter of 3-4 mm and a length of 4-5 mm.

The pellets of cross-linked TPU are a convenient form for storage and transport and can be re-melted and shaped as needed to form shaped cross-linked articles, such as by injection moulding or extrusion.

In a third aspect, the invention provides a cross-linked TPU resulting from step (2) or step (4) of the method of the invention. After melt-blending at least one TPU and a diisocyanate having a boiling point of greater than 200° C. and an aromatic diamine having a boiling point of greater than 200° C. the cross-linked TPU is ground or shaved to yield granules or flakes.

The TPU that may be used in the method of the invention is any polymer that results from reacting at least one diol with at least one diisocyanate. In a particular embodiment, the TPU is formed by the reaction of: (1) at least one diisocyanate with at least one short-chain diol and (2) at least one diisocyanate with at least one long-chain diol. In this context, the expression “short-chain diol” means a diol having 2-6 carbon atoms, and the expression “long-chain diol” means a diol having more than 6 atoms between the terminal hydroxyls.

Preferred short-chain diols are selected from ethylene glycol, propane diol, butane diol and mixtures thereof. Common long chain diols used to make TPU's are polyethers made from ethylene oxide and or propylene oxide and or tetrahydrofuran, and aliphatic polyesters such as those made by the condensation of ethylene glycol or 1,4-butanediol and adipic acid or ring opening polymerization of caprolactone. Long chain diol molecular weights typically fall in the range 500-3500 g/mol.

In a particularly preferred embodiment the at least one TPU is selected from those made from polycaprolactone.

In another preferred embodiment, the at least one TPU is made from a polyether.

The at least one TPU is preferably dried before adding the cross-linking agents (i.e. the diisocyanate and the diamine), as this reduces hydrolysis of the diisocyanate, resulting in more predictable and reproducible cross-linking. Drying can be effected by heating the at least one TPU to below its melting point under dry conditions, for example a stream of dry air or inert gas, or under vacuum.

If significant time elapses between steps (2) and (3) of the method of the invention, and if the cross-linked material has been stored under ambient conditions in which moisture pick-up is possible, it is preferred to dry the cross-linked material before subjecting it to re-melting in step (3), as this reduces hydrolysis of the diisocyanate, resulting in more predictable and reproducible results. Drying can be effected by heating the cross-linked material to below its melting point under dry conditions, for example under a stream of dry air or dry inert gas, or under vacuum.

The cross-linking agents are at least one diisocyanate and at least one diamine. The diisocyanate is selected from those that have a boiling point of at least 200° C., as this prevents boil-off during melt-processing. More preferably the diisocyanate has a boiling point greater than 250° C., more particularly preferably greater than 300° C. Preferred diisocyanates are aromatic diisocyanates having boiling points greater than 200° C. Preferred diisocyanates are solid at room temperature. More preferred diisocyanates are selected from 4,4′-diphenylmethane diisocyanate (“MDI”),

2,4′-diphenylmethane diisocyanate, 2,2′-diphenylmethane diisocyanate, toluene diisocyanate, hexamethylene diisocyanate, naphthalene diisocyanate, and mixtures and polymers of any of these.

A particularly preferred diisocyanate is 4,4′-diphenylmethane diisocyanate (“MDI”).

The process of the invention requires an aromatic diamine having a boiling point of greater than 200° C. Preferred diamines are solid at room temperature. Examples are diethyl 2,4-toluene diamine, methylenedianiline, 4,4′-Methylenebis(2,6-diethylaniline), 4,4′-Methylenebis(2,6-dimethylaniline), 4,4′-Methylene-bis(2-chloroaniline), 4,4′-Methylene-bis(2-methylaniline), 4,4′-ethylenedianiline, 4,4′-Methylenebis-(O-Chloroaniline), 4,4′-methylenebis-(3-chloro-2,6-diethylaniline) (“MCDEA”), and mixtures of these. A particularly preferred diamine is MCDEA.

The diisocyanate is preferably used at 1 to 10 wt % with respect to the at least one TPU, more preferably at 2 to 8 wt %, more particularly preferably at 3 to 7 wt %, most preferably at 6 wt %.

The diamine is preferably used at 0.5 to 10 wt % with respect to the at least one TPU, more preferably at 1 to 5 wt %, most preferably at 3 wt %.

Preferably the diisocyanate is used in molar excess with respect to the diamine. Preferably the molar ratio of the diisocyanate to diamine is 4:1 to 1.5:1, more preferably 2:1.

Preferably the wt % ratio of diisocyanate to diamine is 4:1 to 1.5:1, more preferably 2:1.

Preferred amounts of diisocyanate and diamine (with respect to the at least one TPU) are:

8 wt % diisocyanate to 4 wt % diamine

6 wt % diisocyanate to 3 wt % diamine

Particularly preferred is 6 wt % diisocyanate and 3 wt % diamine.

In a preferred embodiment, the diisocyanate is MDI and the diamine is MCDEA. A particularly preferred combination is MDI at 1 to 10 wt % with respect to the at least one TPU, more preferably at 2 to 8 wt %, more particularly preferably at 3 to 7 wt %, most preferably at 6 wt %, and MCDEA at 0.5 to 5 wt % with respect to the at least one TPU, more preferably at 1 to 4 wt %, most preferably at 3 wt %. Particularly preferred is 6 wt % MDI and 3 wt % MCDEA. Particularly preferred is MDI and MCDEA at a ratio of 2:1.

Some preferred formulations for the method of the invention, in which weight percentages are based on the total amount of the at least one TPU, are:
1. TPU, 6 wt % MDI and 3 wt % MCDEA
2. A TPU comprising polycaprolactone, MDI and MCDEA
3. A TPU comprising a polyether, MDI and MCDEA
4. A TPU comprising polycaprolactone, 6 wt % MDI and 3 wt % MCDEA
5. A TPU comprising a polyether, 6 wt % MDI and 3 wt % MCDEA

In the method of the invention, the at least one TPU, the diisocyanate and the diamine are blended in molten state to create a homogeneous blend. This is typically done in a twin-screw extruder. The order of mixing is not particularly limited. In a preferred embodiment, the at least one TPU is first melted and then the diisocyanate and the diamine are added. In another preferred embodiment, the polymer in solid form, for example as pellets or granules, is mixed with the diisocyanate and diamine as a dry blend. In another preferred embodiment, the diisocyanate and/or diamine are mixed with pellets of the TPU at a temperature at which the TPU is still solid, but which is warm enough to melt the diisocyanate and/or the diamine. This produces a dry blend in which one or both of the cross-linking agents form a coating on the pellets.

The dry blend is fed into a compounding device, such as a twin-screw extruder, to melt-mix the ingredients and cause cross-linking. The temperature of the extruder must be above the melting temperature of the at least one TPU, preferably it is from 5 to 70 degrees C. above the melting point of the at least one TPU. The residence time in the melt is preferably long enough that the at least one TPU, the diisocyanate and the diamine become a homogeneous blend, but not so long that the melt viscosity increases to the point that shaping becomes difficult. Preferably the residence time is at least seconds, more preferably at least 90 seconds.

The method may also comprise an additional step (2′) in which the cross-linked TPU is subjected to a post-curing step consisting of heating to 100 to 150° C., preferably 120° C. for a period of from 6 to 24 hours, preferably 12 hours, after step (2) and before step (3).

Cross-linking of the polymer begins as soon as the diisocyanate and diamine are added to the melt. As soon as the mixture is homogenous it may be shaped into any desired form. The molten mass of cross-linked polymer in step (2) may be shaped into any form. Preferred for transport, storage and ease of re-melting for further processing are pellets, granules and flakes. Pellets are typically made by extruding strands through a die, followed by cooling (for example by quenching in water) and subsequent cutting into pellets. Flakes may be made by shaving or grinding cross-linked material in any form. This includes of course regrinding moulded articles made by the direct process or indirect process, or waste or rejects resulting from the moulding process. Pellets, granules and flakes can be easily packaged (for example in bags), and stored or transported to article manufacturers. Thus, the method of the invention may additionally comprise a step (2″), of grinding or shaving the solidified cross-linked TPU to form flakes, powder or granules. Optional step (2″) is carried out after step (2) or step (2′), and before step (3).

Powder in this context is small particles having an average particle size of from 75 to 750 microns with >95% passing through a 1,000 micron sieve.

Flakes in this context are pieces of polymer having a size of 4-8 mm, flake thickness 0.5-2 mm, flake size ≥8 mm≤1% wt, flake size 2-4 mm 20% wt, flake size≤2 mm≤1% wt. Alternatively, flakes are pieces of polymer having a thickness to width ratio of 1:4 to 1:12 and average dimensions of 2-10 mm by 2-10 mm in the plane.

The method of the invention also includes, in one embodiment, the recycling of shaped articles made by the direct or indirect methods. In such embodiments, the forming in step (2) is, inter alia, extrusion, injection-moulding, compression-moulding or blow-moulding to form an article. After or before use, the resulting article can be subjected to step (2″), detailed above, to render it in a form that can be readily stored, transported and re-melted for reprocessing in steps (3) and (4).

In one aspect, the invention provides a cross-linked TPU resulting from the reaction of at least one TPU and a diisocyanate having a boiling point of greater than 200° C. and an aromatic diamine having a boiling point of greater than 200° C. in extruded form. The extruded form may be pellets made as described above. The pellets are suitable to be re-melted and processed into a cross-linked shaped article. In a further aspect, the invention provides a cross-linked TPU resulting from the reaction of at least one TPU and a diisocyanate having a boiling point of greater than 200° C. and an aromatic diamine having a boiling point of greater than 200° C., in which the cross-linked TPU is in the form of pellets.

In another aspect, the invention provides a cross-linked TPU resulting from the reaction of at least one TPU and a diisocyanate having a boiling point of greater than 200° C. and an aromatic diamine having a boiling point of greater than 200° C. in ground form or flakes. The ground polymer (typically called “regrind” in the polymer arts) may be re-melted and processed into a cross-linked shaped article. Ground polymer or flakes are produced by grinding.

When it is desired to form a cross-linked article, the cross-linked TPU resulting from step (2) is re-melted, for example in a twin-screw extruder and shaped by any method desired, for example, injection moulding, extrusion, blow-moulding. The temperature of the extruder must be above the melting temperature of the at least one TPU, preferably it is from 5 to 70° C. above the melting point of the at least one TPU.

The cross-linked TPU resulting from step (2) and the cross-linked article resulting from step (4) may be tested for cross-linking by determining their solubility in an organic solvent, such as tetrahydrofuran (THF). The cross-linked polymer of step (2) and cross-linked article of step (4) are essentially insoluble in THF, whereas the uncross-linked polymers dissolve.

After step (4) the cross-linked article may be subjected to a post-curing step consisting of heating to 100 to 150° C., preferably 120° C. for a period of from 6 to 24, preferably 12 hours.

The shaped cross-linked article resulting from step (4) has good abrasion-resistance, tensile strength, rebound behaviour, solvent resistance and compression set.

The cross-linked compositions described herein may further comprise additives that include, but are not limited to, one or more of the following components as well as combinations of two or more of these: metal deactivators, such as hydrazine and hydrazide; heat stabilizers; antioxidants; modifiers; colorants; lubricants; fillers (such as glass, mica, barium sulphate, stainless steel, clays) and reinforcing agents; impact modifiers; flow enhancing additives; antistatic agents; crystallization promoting agents; conductive additives; viscosity modifiers; nucleating agents; plasticizers; mold release agents; scratch and mar modifiers; drip suppressants; adhesion modifiers; and other processing aids known in the polymer compounding art. These additives may be added to the polyester or copolyetherester by methods that are known in the art.

In particular, the compositions may comprise poly(dimethylsiloxane) (“PDMS”), preferably at 1-8 wt %, more preferably 2-5 wt % or 3 wt % PDMS, based on the weight of TPU. Inorganic fillers, when used, are preferably present at up to 30 wt %, based on the weight of TPU. When used, the other additive(s) are preferably present in amounts of about 0.1 to about 20 weight percent, based on the total weight of TPU. Preferably, no individual other additive is present at a level of more than 5 wt %, based on the total weight of TPU.

One property that is improved by cross-linking is solvent resistance. Solvent resistance can be measured, for example, by measuring weight gain after soaking in an organic solvent. Weight gain is typically expressed as a percentage (%) based on the original, un-soaked sample. For example, if test pieces according to ISO527 are soaked in acetone for 22 hours at 20-24° C., the weight gain in percent of the cross-linked TPU and the cross-linked TPU article should preferably be less than 60%, more preferably less than 55%.

Another property that is improved by cross-linking is compression set. Compression set can be measured, for example, according to ASTM D395 method B [70° C., 22 hours]. Initial (pre-compression) and final (after compression and cooling) heights are compared to calculate the compression set, which is reported as percent (%). Compression set of the cross-linked TPU and the cross-linked TPU article should preferably be less than 29%, more preferably less than 25%.

Another property that is improved by cross-linking is Taber abrasion. Taber abrasion can be measured using a D1044 H-18 wheel 1 kg load—A Teldyne Taber Abraser model 503 taber abrasion tester fitted with 1 kg load and H-18 abrasion wheel, which is used to measure weight loss on a die cut 4″ disc sample after 1000 revolutions at 72 revolutions per minute. The cross-linked TPU and cross-linked TPU article preferably have a loss (mg/1000 rev.) of less than 50, more preferably less than 45.

The shaped cross-linked article is not particularly limited as to application. Some exemplary fields of application for cross-linked TPU's include oil and gas applications. Particularly preferred applications include rod guides, cone packs, seals and gaskets.

The following examples are provided to describe the invention in further detail.

These examples, which set forth a preferred mode presently contemplated for carrying out the invention, are intended to illustrate and not to limit the invention.

### EXAMPLES

Chemicals:

MDI=4,4′-diphenylmethane diisocyanate

MCDEA=4,4′-Methylenebis(3-Chloro-2,6-Diethylaniline)

TPU1=polycaprolactone-based TPU

To demonstrate the method of the invention, TPU was cross-linked by melt-blending in an extruder: TPU, MDI and MCDEA, with cross-linked test pieces being formed immediately by injection molding directly from the extruder (conventional comparative method, also called the Direct Method because the cross-linking and moulding occur essentially simultaneously). These test pieces were compared with test pieces made by re-melting cross-linked TPU flakes followed by injection molding into test pieces (method of the invention, also call the Indirect Method). As a further comparison, un-cross-linked TPU was injection molded into test pieces.

Blending, Preparation of the Indirect Process Sample, Plaque Molding, Heat Treating and Test Specimen Manufacture

### Comparative Examples 1 and 2

TPU1 was dried (Conair dehumidified air dryer) at 85° C. for 4 hr.

Compositions:
1) TPU1 [uncross-linked, Comparative Example 1]
2) TPU1+6% MDI+3% MCDEA [cross-linked, Direct Method, Comparative Example 2]
   a. TPU1 was removed from the dryer as it cooled, pellet temperature was approximately 60° C.
   b. 20 lb TPU1 was added to a canco pail, together with 1.2 lb MDI, the lid was attached and the canco pail was tumbled for 30 minutes to allow the MDI flakes to melt and coat the TPU1 pellets and freeze as the pellets cooled below 40° C.
   c. The lid was removed from the canco pail, and 0.6 lb MCDEA was added to the canco pail, the lid was reattached and the canco pail was tumbled for 10 minutes to ensure mixing of the MCDEA with the MDI coated TPU pellets. This formed the dry blend that was fed to the injection moulding machine.

A Borche BS260-III injection moulding machine was used to prepare 6″×6″×⅛″ plaques. Molding conditions are in Table 1. Plaques from Comparative Example 1 were marked P1 and were the unmodified TPU control, and plaques from Comparative Example 2 were marked P2 and were the Direct Method TPU.

### Example 1

A second set of molding was performed where (thick parts) resembling a squeegee were molded from the cross-linked TPU of Comparative Example 2 above. These thick parts were allowed to cool and after 2 days were ground to flake using a standard plastic part grinder (Industrial Machinery Sales & Services MI-5 grinder). This regrind was then dried (85° C., 4 hr, dehumidified air) and re-melted in an extruder and molded into 6″×6″×⅛″ plaques using the same molding machine as described previously using molding conditions in Table 1. These plaques were marked as P3 and represent the Indirect Method TPU example (i.e. process of the invention).

A subset of the plaques molded P1, P2 and P3 were heat-treated by heating in an air circulating oven for 12 hr at 250 F. These plaques were marked P1H, P2H and P3H.

Compression set discs (1″ diameter), ASTM D1708 micro-tensile bars, and taber abrasion discs (4″ diameter) tensile bars were die cut from plaques P1, P1H, P2H and P3H.

TABLE 1
Molding conditions

| Material Sample | P1 | P2 | P3 |
|---|---|---|---|
| Barrel - Rear | 180° C. | 180° C. | 195° C. |
| Barrel - Middle | 195° C. | 195° C. | 205° C. |
| Barrel - Front | 200° C. | 200° C. | 205° C. |
| Nozzle temperature | 205° C. | 205° C. | 210° C. |
| Mold temperature | 25° C. | 25° C. | 25° C. |

Tests

The following tests were performed and the results are listed in Table 2.

Compression set, ASTM D395-18 method B [70° C., 22 hr]—Compression set buttons were made by plying up four 1″ diameter discs to provide a nominal 0.5″ thick test sample. Samples were loaded in duplicate into a metal compression jig with 0.375″ spacers and tightened to compress the original sample to 0.375″ height (nominally 25% compression). Compression set jigs were placed in a 70° C. air circulating oven for 22 hr after which they were removed and opened within 2 minutes and the test samples removed and placed on a wooden surface to allow them to cool. Initial (pre-compression) and final (after compression and cooling) heights were compared to calculate the compression set, which is reported as percent (%). A lower number indicates improved compression behaviour.

Taber Abrasion, ASTM D1044-13 H-18 wheel 1 kg load—A Teldyne Taber Abraser model 503 taber abrasion tester fitted with 1 kg load and H-18 abrasion wheel was used to measure weight loss on the die cut 4″ disc samples after 1000 revolutions at 72 revolutions per minute. A lower number indicates less loss, meaning the sample has improved abrasion resistance.

Solvent Swell—Micro-tensile bars were weighed and then placed in 4 oz straight sided glass jars to which 35 g of solvent grade acetone was added. The jars were sealed with a screw lid and left for 22 hr at ambient temperature (˜23° C.). Upon opening the jars, microtensile bars were removed from the acetone, patted dry with a lab towel, and weighed within 15 sec of removal from the solvent. Acetone solvent swell was calculated as (final weight—initial weight)/initial weight. A similar set of testing was performed using tetrahydrofuran as the solvent. A lower number indicates less solvent swell.

TABLE 2
Compression set, Taber abrasion and solvent swell (acetone,
THF) for Comparative Examples and Example 1

| Material Sample | P1 | P1H | P2H | P3H |
|---|---|---|---|---|
| Cross-linking Process | — | — | direct | Indirect |
| | | | | (invention) |
| Heat treated - 12 hr, | No | Yes | Yes | Yes |
| 250 F. | | | | |
| Compression set B | 71% | 30% | 23% | 24% |
| (22 hr @ 70° C.) | | | | |
| Taber Abrasion H-18 | n/m | 60 | 37.4 | 40.4 |
| [mg/1000 rev] | | | | |
| Solvent swell - | n/m | 65.0% | 51.0% | 50.8% |
| acetone | | | | |
| Solvent swell - | n/m | dissolved | 376% | 381% |
| tetrahydrofuran | | | | |

Interpretation

Cross-linking of TPU1 with 6 wt % MDI and 3 wt % MCDEA during injection molding, the direct process (P2H), offers property advantages vs. plain TPU1 (P1H) as demonstrated by improved abrasion resistance (reduced Taber abrasion loss) and improved compression set (lower set) and improved solvent resistance (lower swell). Furthermore, the uncross-linked sample (P1H) dissolves in THF, whereas the cross-linked material (P2H) does not dissolve.

Surprisingly, for a cross linked material, material formed from the direct process can be additionally melt processed, i.e., re-melted and processed, without significant change in properties. After melt processing the cross-linked material (P3H) shows property advantages over non-modified TPU (see improved compression set, abrasion resistance and reduced solvent swell vs. P1H) which are not significantly different from those measured on the originally cross-linked materials [compare P3H (method of the invention) with P2H (Direct Method)]. This shows that the cross-linking is reversible, as the improved, cross-linked properties are maintained after re-melting and forming.

While certain of the preferred embodiments of this invention have been described and specifically exemplified above, it is not intended that the invention be limited to such embodiments. Various modifications may be made without departing from the scope and spirit of the invention, as set forth in the following claims.

1. A method for producing a cross-linked TPU article, comprising the steps:
(1) creating a molten blend of at least one TPU, a diisocyanate having a boiling point of greater than 200° C. at 1-10 wt %, an aromatic diamine having a boiling point of greater than 200° C. at 0.5-10 wt %, where the weight percentages are based on the weight of the TPU;
(2) forming the molten blend and allowing it to solidify to a solidified cross-linked TPU;
(3) re-melting the solidified cross-linked TPU; and
(4) forming a cross-linked TPU article.

2. The method of claim 1, wherein the diisocyanate is used in molar excess with respect to the diamine.

3. The method of claim 1, comprising an additional step (2′), of curing the cross-linked TPU by heating to 100 to 150° C., after step (2) and before step (3).

4. The method of claim 1, wherein the at least one TPU is a polyether-based TPU, a polycaprolactone based TPU, or a polyether-based TPU.

5. (canceled)

6. (canceled)

7. The method of claim 1, wherein the diisocyanate is selected from those having a boiling point greater than 300° C.

8. The method of claim 1, wherein the diisocyanate is selected from 4,4′-diphenylmethane diisocyanate (“MDI”), 2,4′-diphenyl-methane diisocyanate, 2,2′-diphenylmethane diisocyanate, toluene diisocyanate, hexamethylene diisocyanate, naphthalene diisocyanate, and mixtures and polymers of any of these; or wherein the diamine is selected from methylenedianiline, 4,4′-Methylenebis(2,6-diethylaniline), 4,4′-Methylenebis(2,6-dimethylaniline), 4,4′-Methylene-bis(2-chloroaniline), 4,4′-Methylene-bis(2-methylaniline), 4,4′-ethylenedianiline, 4,4′-Methylenebis-(O-Chloroaniline), 4,4′-methylenebis-(3-chloro-2,6-diethylaniline) (“MCDEA”), and mixtures of these.

9. (canceled)

10. (canceled)

11. (canceled)

12. The method of claim 1, wherein the diisocyanate is used at 1 to 10 wt % with respect to the at least one TPU; or wherein the diamine is used at 0.5 to 5 wt % with respect to the at least one TPU.

13. (canceled)

14. The method of claim 1, wherein the diisocyanate is used at 6 wt % and the diamine is used at 3 wt %, both with respect to the at least one TPU.

15. The method of claim 1, wherein in step (2) the molten blend is extruded as a strand followed by cutting of the strand such that the solidified cross-linked TPU is in the form of pellets.

16. The method of claim 15, wherein the pellets have the following dimensions:
(1) a diameter of 3-4 mm and a thickness of 2-3 mm; or
(2) a diameter of 3-4 mm and a length of 4-5 mm.

17. The method of claim 1, comprising an additional step (2′) consisting of grinding or shaving the solidified cross-linked TPU to form flakes, powder or granules after step (2) and before step (3).

18. The method of claim 1, wherein the diisocyanate is 6 wt % MDI and the diamine is 3 wt % MCDEA.

19. The method of claim 1, wherein in step (1) the molten blend is maintained at 5 to 70° C. above the melting point of the at least one TPU for at least a period of 30 seconds.

20-23. (canceled)

24. A cross-linked TPU resulting from melt-blending at least one TPU and a diisocyanate having a boiling point of greater than 200° C. and an aromatic diamine having a boiling point of greater than 200° C., wherein the cross-linked TPU is in extruded form or in the form of granules or flakes.

25. The cross-linked TPU of claim 24, wherein the TPU is a polycaprolactone based TPU, a polyether-based TPU, or a polyether-based TPU.

26. The cross-linked TPU of claim 24, wherein the diisocyanate is selected from those having a boiling point greater than 300° C.

27. The cross-linked TPU of claim 24, wherein the diisocyanate is selected from 4,4′-diphenylmethane diisocyanate (“MDI”), 2,4′-diphenylmethane diisocyanate, 2,2′-diphenylmethane diisocyanate, toluene diisocyanate, hexamethylene diisocyanate, naphthalene diisocyanate, and mixtures and polymers of any of these or wherein the diamine is selected from methylenedianiline, 4,4′-Methylenebis(2,6-diethylaniline), 4,4′-Methylenebis(2,6-dimethylaniline), 4,4′-Methylene-bis(2-chloroaniline), 4,4′-Methylene-bis(2-methylaniline), 4,4′-ethylenedianiline, 4,4′-Methylenebis-(O-Chloroaniline), 4,4′-methylenebis-(3-chloro-2,6-diethylaniline) (“MCDEA”), and mixtures of these.

28. (canceled)

29. (canceled)

30. (canceled)

31. The cross-linked TPU of claim 24, wherein the diisocyanate is used at 1 to 10 wt % with respect to the at least one TPU; wherein the diamine is used at 0.5 to 5 wt % with respect to the at least one TPU: or wherein the diisocyanate is used at 6 wt % and the diamine is used at 3 wt %, both with respect to the at least one TPU.

32. (canceled)

33. (canceled)

34. The cross-linked TPU of claim 24 which is in the form of pellets.

35. The cross-linked TPU of claim 34, wherein the pellets have the following dimensions:
(1) a diameter of 3-4 mm and a thickness of 2-3 mm; or
(2) a diameter of 2-3 mm and a length of 4-5 mm.

36. (canceled)
